(19) United States
(12) Patent Application Publication
(10) Pub. No.: US 2025/0262037 A1
(43) Pub. Date: Aug. 21, 2025

(54) Dental Flossing device

(71) Applicant: Fonster, LLC, Anchorage, AK (US)

(72) Inventor: Benjamin S. Warren, Annapolis, MD (US)

(21) Appl. No.: 19/056,761

(22) Filed: Feb. 19, 2025

Related U.S. Application Data
(60) Provisional application No. 63/555,402, filed on Feb. 20, 2024.

(51) Int. Cl. A61C 15/04

(52) U.S. Cl. CPC A61C 15/046

(57) ABSTRACT

A dental flossing device for cleaning the teeth of a user is provided. The dental flossing device includes a pair of handles interconnected together by floss. Each handle includes a top body and a bottom body. The bottom body includes a tip and a dispensing hole to allow dental floss to be dispensed. A depressible actuator button is disposed at the top of the top body to wind and unwind/release a predetermined length of floss. The top body and the bottom body are removably connected to define a cavity. A floss spool, a spool rest, and a spring are positioned inside the cavity. The dental flossing device allows the user to vary the length of floss between two handles, allowing for a better flossing technique. Further, the solid single-structure tip of the dental flossing device is hygienic and without any seams, thus helping to avoid potential bacteria traps.

### CROSS-REFERENCE TO RELATED APPLICATIONS

The present application hereby claims priority to and incorporates by reference the entirety of the disclosures of the provisional application No. 63/555,402 entitled “Dental Flossing Device”, filed on Feb. 20, 2024.

### TECHNICAL FIELD

The present invention generally relates to the field of dental hygiene. More particularly, the present invention relates to a hand-held dental flossing device that includes a pair of handles dispensing floss for cleaning tooth of a user.

### BACKGROUND

The practice of dental flossing has been an integral component of oral hygiene routines for centuries, with its origins dating back to ancient civilizations. The motivation behind flossing stems from the recognition of its important role in maintaining oral health by effectively removing plaque and food debris from interdental spaces. This preventive measure not only mitigates the risk of dental caries and periodontal diseases but also contributes to fresher breath and overall dental well-being. Despite advancements in oral care technologies, the enduring popularity of flossing persists due to its simplicity, accessibility, and proven efficacy in promoting dental hygiene. Understanding the underlying reasons driving individuals to incorporate flossing into their daily regimen is crucial for further innovation in oral care products and techniques.

Generally, dental floss is a cord of thin nylon filaments or a plastic (Teflon or polyethylene) ribbon used to remove food and dental plaque from teeth. The dental floss is gently inserted between the teeth and scraped along the teeth' sides, especially close to the gums to remove food and dental plaque from between teeth. Many types of dental floss already exist in the market and are available in different designs and sizes to suit the requirements of the user. These dental flosses may be flavored or unflavored, waxed or unwaxed, and can use a variety of mechanisms to achieve tooth cleaning purposes.

Many floss users find it difficult to grasp, manipulate, and use the floss itself. Thus, a variety of devices have been developed to make flossing easier.

For instance, U.S. Pat. No. 9,016,287B2 discloses a dental flossing device in which dental floss is strung between a dispensing side handle, which dispenses dental floss and goes into a receiving side handle, which receives used dental floss. However, U.S. Pat. No. 9,016,287B2 comprises a spooling mechanism to dispense dental floss that is part of a dispensing wheel. The spooling mechanism requires finger pressure or friction, which are less predictable and less accurate. The plastic seams on this dental flossing device that extend into the tip of device are unhygienic; which could be a potential location for bacterial growth. Further, there is no actuator button to spool/un-spool a prescribed (set) length of floss.

U.S. Pat. No. 9,265,593B2 discloses a flossing system including a cradle and a housing. The flossing system includes an array of floss cartridges having a length of floss. The array of floss cartridges includes a pair of coupling members each coupled to opposite ends of the length of floss. Each floss cartridge includes a coupling structure. The flossing system includes a pair of floss handles disposed on the cradle and selectively couplable to the coupling members. The pair of floss handles includes a cylindrical body. The pair of floss handles include a release mechanism configured to selectively disengage the floss handle from the coupling member. The release mechanism includes an actuation member disposed through a back end of the cylindrical body of each of the pair of floss handles. The pair of floss handles each include a top aperture configured to receive the coupling structure of the pair of coupling members. However, U.S. Pat. No. 9,265,593B2 device requires disposable, predetermined lengths of floss embedded in plastic that attach to handles and the floss cannot be varied in length, and the user must buy replacement floss pieces and the user is unable to adapt one's own choice of floss to the device. Further, the handles are small and can be difficult to grip; and there is no reservoir of floss and the user is unable to obtain a new piece of floss from the reservoir inside one handle.

U.S. Pat. No. 6,895,977B2 discloses a dental flossing tool for dispensing floss for cleaning the user's teeth. A handle body surrounds a cavity and has a lead riser from which dental floss is dispensed for use. The floss is wound upon a spool that rotates inside the cavity. Floss is paid out from the spool and emerges from a hole in the tip of the lead riser. A button or handle is slidably mounted upon the apparatus for controlling the longitudinal movement of a retainer within the cavity of the apparatus. By sliding the button handle forward and backward, the user can disengage and engage the retainer with a baffle attached to the spool inside the body of the apparatus. When the retainer is in contact with the baffle, the spool is prevented from rotating, thereby stopping any further floss from being dispensed. When the retainer is disengaged out of contact with the baffle, the spool is free to rotate to pay out floss. A removable protector is provided for covering the lead riser and a floss cutter blade is attached to the exterior of the apparatus. The protector can be removed to the back end of the apparatus to extend its graspable portion for easier handling. However, the dental flossing tool of U.S. Pat. No. 6,895,977B2 requires that the user holds the other (free) end of floss with a hand, and the floss is not advanced through the use of an actuator button that dispenses a prescribed amount of floss.

The existing solutions related to dental floss are ineffective, inefficient, have some design flaws, and/or are unhygienic. Thus, there remains a need to suggest an effective and efficient dental flossing device capable of solving the aforementioned problems of the existing solutions. The proposed novel dental flossing device allows the user to vary the length of floss between two handles (shorter floss to use in smaller spaces; longer floss for larger spaces), allows for better flossing technique (C-shape adaptation to interproximal surfaces of teeth), handles are ergonomically designed such that handles are easier to grip for users with dexterity challenges, arthritic problems and/or having large hands as compared to the smaller handle alternatives existing in the market. Further, the solid single-structure tip of the proposed novel dental flossing device is hygienic without any seams, thus avoiding potential bacteria traps.

### SUMMARY

Before the present systems and methods, and embodiments are described, it is to be understood that this application is not limited to the particular systems, and methodologies described, as there can be multiple possible embodiments that are not expressly illustrated in the present disclosures. It is also to be understood that the terminology used in the description is for the purpose of describing the particular versions or embodiments only, and is not intended to limit the scope of the present application. Further, it is also to be understood that the terminology if not defined by the present disclosure should be construed as the general or known meaning/definition of the terminology, known to the person skilled in the art.

It is an object of the present invention to provide a dental flossing device that allows the user to vary the length of floss between two handles such that the user can choose between shorter floss to use in the smaller spaces and longer floss to use in the larger spaces.

It is an object of the present invention to provide a dental flossing device that allows C-shape adaptation to interproximal surfaces of teeth, thus providing a better flossing technique.

It is an object of the present invention to provide handles for the dental flossing device that are ergonomically designed making them easier to grip for those users with dexterity challenges, arthritic problems, and/or large hands.

According to an example aspect of the present invention, there is provided a dental flossing device for cleaning the teeth of a user. The device includes a pair of handles interconnected together by a floss. Each handle includes a top body, and a bottom body connected together to define a cavity. The bottom body includes a tip with a dispensing hole to allow dental floss to be dispensed there through. The top body, and the bottom body are removably connected using a screw thread arrangement. The bottom body (106) includes a tip with a dispensing hole to allow dental floss to pass through the floss spool, a floss feed through channel and a guide boss. The top body of each handle (100) comprises an ergonomically designed gripping portion to allow the user to grip the top body using their hands.

According to the same aspect, the device includes a floss spool positioned inside the cavity to store and selectively release the floss through the dispensing hole. The floss spool engages with an actuator button configured at the top body to selectively wind, and unwind a predetermined length of floss. The floss spool comprises a plurality of guides to enable rotation of the flash spool by a predetermined distance when the actuator button is actuated either to wind or unwind the floss. The floss spool is configured to engage with the floss utilizing a means of engagement that connects a hole located on a central shaft of the floss spool. The floss spool rests against the spring and/or the washer on one end and engages with the actuator button at the other end.

According to the same aspect, the device includes a spool rest positioned inside the cavity and configured for guiding the floss, supporting the floss spool, and allowing for winding and unwinding of floss relative to the floss spool. The spool rest includes a central shaft that centrally supports the floss spool, a circular wall that acts as a base for floss, wherein the circular wall comprises a floss feed through a hole, and a guide pocket. The spool rest further includes a flexible guiding element configured to press towards the spool of floss, wherein the flexible guiding element comprises an opening. The spool rest further includes a plurality of anti-tilt support walls that support the placement of the spool rest, and wherein the central shaft, the flexible guiding element, and the plurality of anti-tilt support walls extend from the circular wall.

According to the same aspect, the floss is made of a flexible material selected from at least synthetic waxed nylon, Teflon, and silk.

According to the same aspect, the tapered end of the tip is rounded to avoid damage to the floss, and damage to the user's gingival tissue. The tip further comprises an attachment made of a softer material for greater comfort adjacent to gums when flossing with the dental flossing device.

According to the same aspect, the dental flossing device further includes a clip-on attachment configured to re-direct the floss as the floss leaves the tip to permit flossing under a wire when orthodontic brackets and wires are in place.

According to the same aspect, the actuator button is depressible and configured at the top of the top body to selectively wind and unwind the predetermined length of floss.

According to the same aspect, the top body and the bottom body may be removably connected by a connection mechanism selected from a group of mechanisms consisting of a luer lock, a twist lock, magnetic coupling, friction coupling, snap-fit coupling, key and keyways, screw and bolt coupling.

According to the same aspect, the depth and number of guides are adjustable to alter the predetermined distance of floss that's unwinded or winded up with pressing the actuator button.

According to the same aspect, the dental flossing device further includes a spring positioned between the spool rest and the floss spool inside the cavity, wherein the spring is adapted to deliver the necessary force to counter the force exerted when the actuator button is depressed, and effectively causes spooling of the floss as the floss spool engages with the actuator button; and a washer placed on one or both ends of the spring to allow for free movement and rotation of spring during the action of spooling.

According to the same aspect, the actuator button when pressed, the floss spool turns following the plurality of guides within the top body, and the actuator button when released, the floss spool returns to its original position, and the floss spool rotates by a prescribed amount as determined by the guides on the floss spool and within the top body.

According to the same aspect, the floss feed through hole, the guide pocket, the opening, the floss feed through channel of the bottom body together collectively define a passage for dispensing the dental floss through a dispensing hole.

According to the same aspect, the floss is guided and threaded between and through the various parts of each of the handles using a floss threader.

According to the same aspect, the handles of the device are configured to allow for winding the floss in opposite directions.

According to another aspect of the present invention, a dental flossing system for cleaning the teeth of a user includes a pair of handles interconnected together by a floss, wherein each handle of the pair of handles comprises a top body and a bottom body connected together to define a cavity, wherein the bottom body includes a tip with a dispensing hole to allow dental floss to be dispensed there through. The dental flossing system includes a floss spool positioned inside the cavity to store and selectively release the floss through the dispensing hole, wherein the floss spool engages with an actuator button configured at the top body to selectively wind, and unwind a predetermined length of floss. According to the same aspect, the dental flossing system includes a spool rest positioned inside the cavity and configured for guiding the floss, supporting the floss spool, and allowing for winding and unwinding of floss relative to the floss spool. The dental flossing system includes a floss threader adapted to guide and thread the floss between and through the various parts of each of the handles. The floss threader is flexible and comprises a knot to which the floss is tied, and an elongated portion that's pulled by the user such that the dental floss is threaded through various parts of the handle.

According to another aspect of the present invention, the dental flossing system for cleaning the teeth of a user may include a case adapted to store the flossing device when it is not being used. The case is at least substantially rectangular or made narrower at the tips and wider at the handles to form the shape of candy corn.

It is an object of the present invention to provide a tip of the dental flossing device that has a solid single structure (unibody) in design and is hygienic and without any seams, thus avoiding potential bacteria traps.

### BRIEF DESCRIPTION OF DRAWINGS

FIG. 1 illustrates a front view of a dental flossing device, according to an embodiment of the present invention;

FIG. 2 illustrates a user using the dental flossing device of FIG. 1 to clean their teeth;

FIG. 3 illustrates a front view of a single handle of the dental flossing device of FIG. 1;

FIG. 4 illustrates a sectional view of the handle of FIG. 3;

FIG. 5 illustrates an exploded view of the handle of FIG. 3;

FIGS. 6-8 illustrates various perspective views of a spool rest of the handle of FIG. 5, according to an embodiment of the present invention;

FIG. 9 illustrates a perspective view of a bottom body of the handle of FIG. 5, according to an embodiment of the present invention;

FIG. 10 illustrates a sectional perspective view of the bottom body of the handle of FIG. 5, according to an embodiment of the present invention;

FIG. 11 illustrates a sectional perspective view of the handle of FIG. 5 in the assembled position, wherein the floss spool is not shown for the sake of simplicity and ease of understanding;

FIG. 12 illustrates an exploded view of the handle of FIG. 11; and

FIG. 13 illustrates a perspective view of a floss threader, according to an embodiment of the present invention.

### DETAILED DESCRIPTION

Before describing the present invention in detail, it should be observed that the present invention utilizes a combination of components or processes, which constitutes a dental flossing device. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Some embodiments, illustrating its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

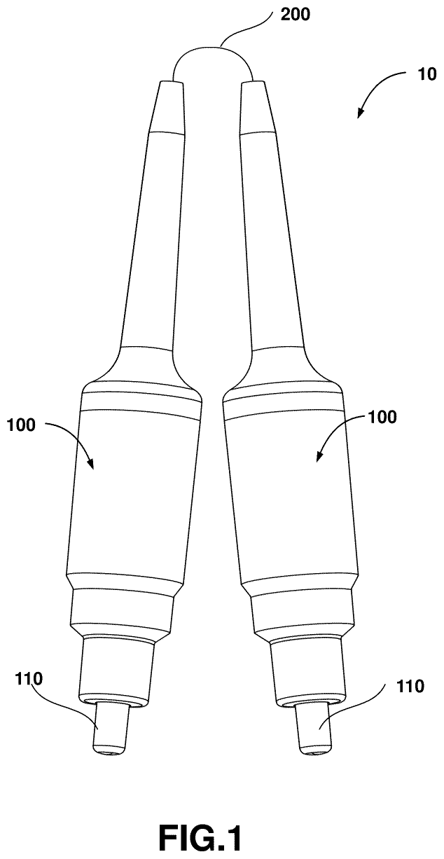

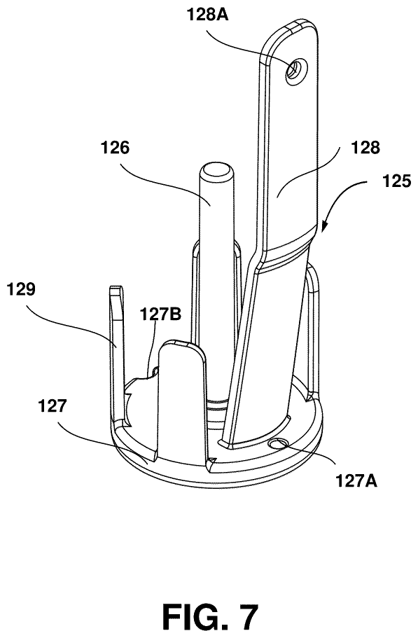

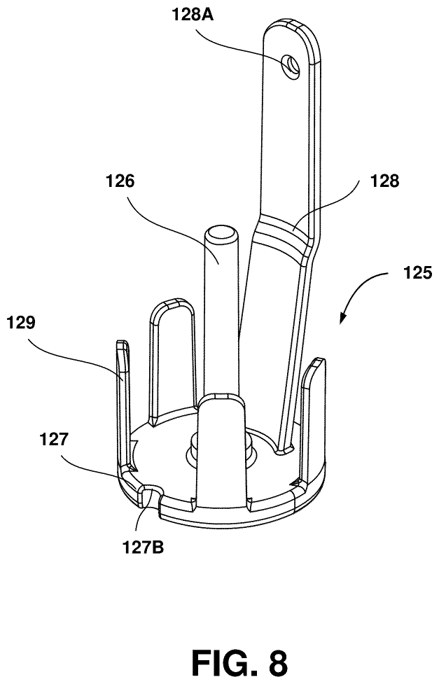

The dental flossing device or dental flossing system will now be described with reference to the accompanying drawings, particularly FIGS. 1-13.

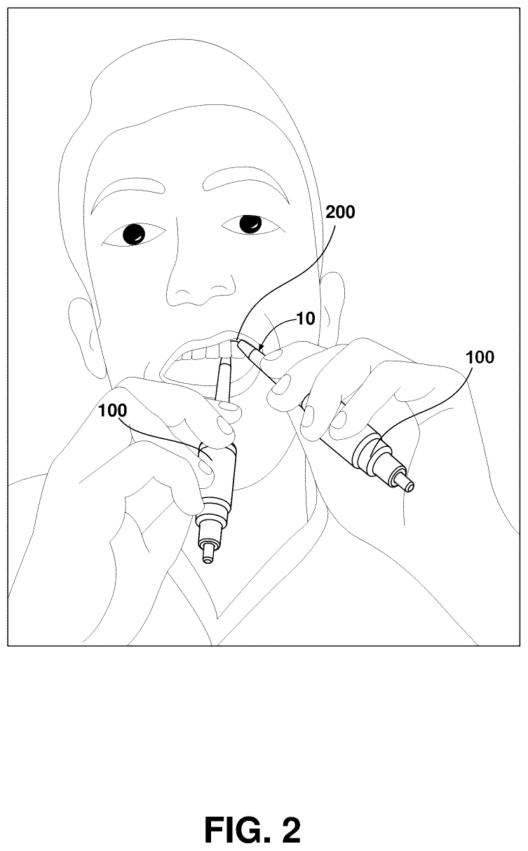

FIGS. 1-8 illustrates a front view of a dental flossing device 10, according to an embodiment of the present invention. The dental flossing device 10 includes a pair of handles 100 that are interconnected together by a floss 200, the entirety of which will be described in greater detail in the below description. The floss 200 is essentially a cord of flexible material capable of being rolled on a spool. The flexible material may include but is not limited to synthetic waxed nylon, Teflon, silk, and so on. The dental flossing device 10 is configured to clean (floss) the teeth of a user as shown in FIG. 2. As seen in FIG. 2, the user can grasp both handles 100 using both hands and can perform the desired cleaning of teeth by bringing floss 200 in contact with their teeth. It should be understood that both handles 100 are identical in design and shape and thus, are collectively referred to as “a pair of handles 100” and are individually referred to as “handle 100”.

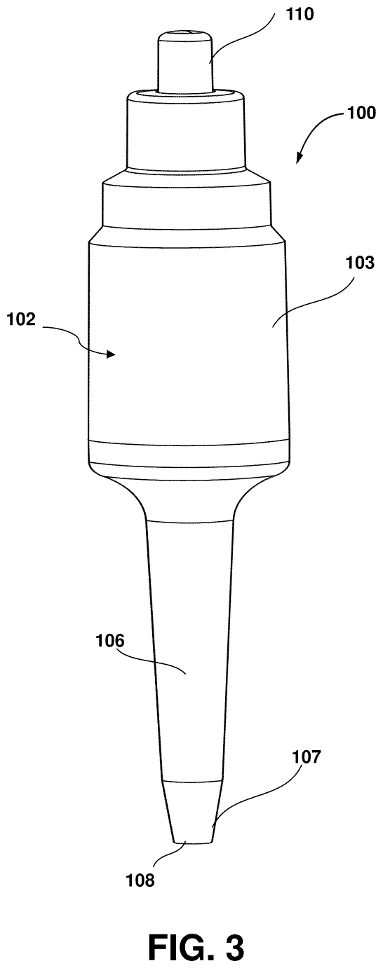

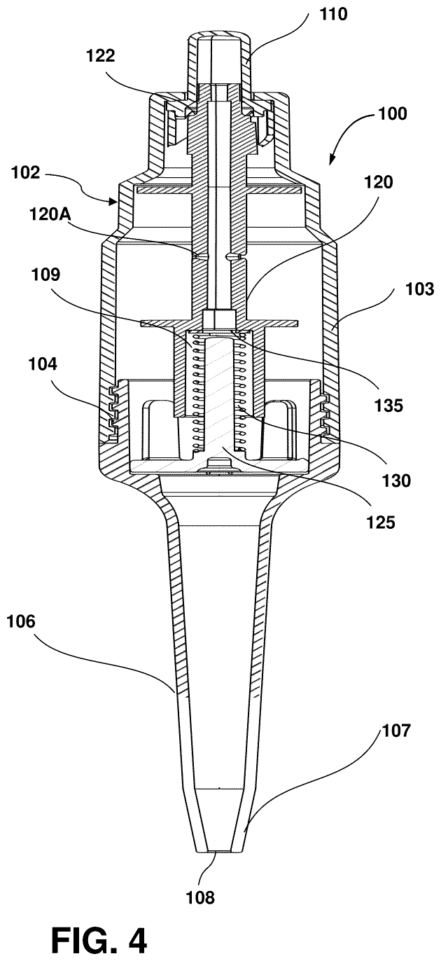

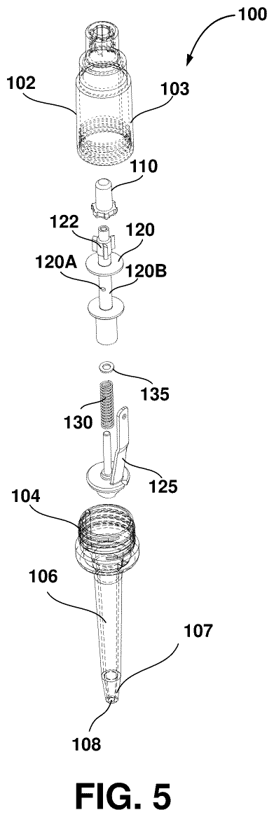

FIGS. 3-5 illustrate a front view, a sectional view, and an exploded view of the handle 100, respectively. The handle 100 includes a top body 102, and a bottom body 106 that are removably connected. In an embodiment, as seen in FIG. 4 and FIG. 5, the top body 102 and the bottom body 106 are removably connected by screw thread arrangement 104 to define a cavity 109 that includes a floss spool 120 that will be described in detail in the below description.

The bottom body 106 comprises a dispensing hole 108 to allow dental floss 200 (FIG. 1) to dispense (pass) through. The bottom body 106 comprises a tip 107 that is unitary (unibody) in design and does not have any seams, and thus does not have any bacteria buildup site for any potential bacteria. The unitary tip 107 allows the floss 200 (FIG. 1) to be delivered at a distance from the floss spool 120. Further, in an embodiment as seen in FIGS. 3-4, the tapered end of the unitary tip 107 is rounded to avoid damage to the floss 200 (FIG. 1), as well as to the user's gingival tissue. In various other embodiments (not shown in figures), the tip 107 may be curved, the contour of tip 107 and opening of tip 107, length, width, and taper of tip 107 may be varied to accommodate different mouths of the users. In another embodiment (not shown in figures), a clip-on attachment (not shown in figures) may be fabricated to re-direct the floss 200 as the floss 200 leaves the tip 107 to permit flossing under a wire when orthodontic brackets and wires are in place. In some other embodiment, the tip 107 may include an attachment (not seen) made of a softer material for greater comfort adjacent to gums when flossing with the device 10.

A clickable (depressible) actuator button 110 is disposed at the top of the top body 102 to wind and release a predetermined length of floss 200 (FIG. 1). The general mechanism of the actuator (floss release) button 110 is similar to that of a retractable pen as described earlier in U.S. Pat. No. 3,819,282, and U.S. Pat. No. 4,968,168, but with a difference in that the floss spool 120 is engaged with the actuator (floss release) button 110, so that the floss spool 120 may not rotate when the actuator button 110 is not engaged.

The top body 102 comprises a gripping portion 103 to allow a user to grip the top body 102 using their hands. The gripping portion 103 is ergonomically designed such that handle 100 is also easier to grip for those users with dexterity challenges, arthritic problems, and/or having large hands as compared to the smaller handle alternatives already existing in the market. However, it should be understood that the size and shape of the gripping portion 103 can be varied to better suit the requirements of the user.

In another embodiment (not shown in figures), the top body 102 and the bottom body 106 are removably connected by a connection mechanism such as but not limited to luer lock, twist lock, magnetic coupling, friction coupling, snap-fit coupling, key and keyways, screw and bolt coupling, and so on.

A floss spool 120 is positioned inside the cavity 109 to store and release the floss 200 (FIG. 1) wherein the floss spool 120 engages with the actuator (floss release) button 110 on the handle 100. The floss spool 120 comprises guides (grooves) 122 to enable rotation of floss spool 120 by a predetermined distance when the actuator (floss release) button 110 is actuated (depressed). The floss spool 120 is enclosed inside the cavity 109 to store and release the floss 200 (FIG. 1) in discrete amounts (quantity). Depth and number of guides (grooves) 122 can be varied to alter the predetermined distance of floss 200 (FIG. 1) that is dispensed/taken up with each pressing of the actuator button 110. The floss spool 120 is configured to engage with a means (means of engagement) to engage the floss 200 (FIG. 1) such as a hole 120A located on the central shaft of the floss spool 120. The spooling mechanism enabled by the floss spools 120 of the pair of handles 100 with their respective actuator buttons 110 transfers the floss 200 between the two handles 100 in a prescribed manner and provides secure tension on the floss 200 between pushes of the actuator buttons 110. In another embodiment, the two handles 100 might allow for winding in opposite directions. For example, a user may press the actuator button 110 of one handle 110 to wind up the floss 200 clockwise, and the user may press the actuator button 110 on the other handle 110 to wind up the floss 200 counterclockwise.

In another embodiment (not shown in figures), the spool design of floss spool 120 is customizable to accommodate a separate spool similar to existing floss spools on the market, so the central shaft 120B of the existing floss spool engages in the center of the floss spool of floss 200, preventing spooling/unspooling of floss 200, except when actuator button 110 is depressed.

A spring 130 and an optional washer 135 are disposed of inside the cavity 109. The spring 130 is positioned between a spool rest 125 and floss spool 120, wherein the spring 130 delivers the necessary force to counter the force exerted when the actuator button 110 is depressed, and effectively causes spooling of the floss 200 (FIG. 1) as the floss spool 120 engages with the actuator button 110. The washer 135 (optional) may be placed, if needed, on one or both ends of the spring 130 to allow for free movement and rotation of spring 130 during the action of spooling.

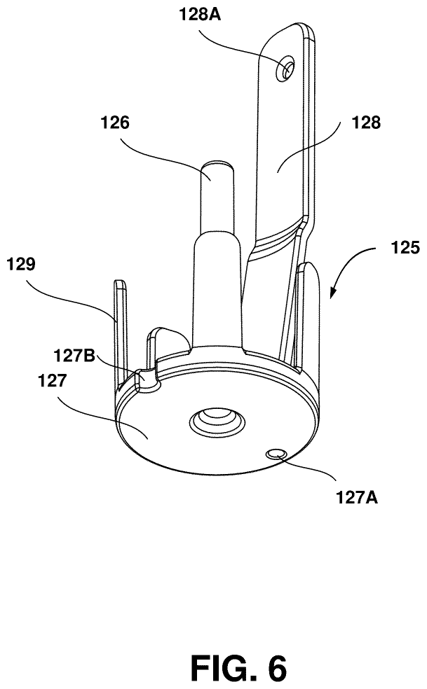

FIGS. 6-8 illustrate various perspective views of the spool rest 125 of the handle 100, according to an embodiment of the present invention. The spool rest 125 guides the floss 200 (FIG. 1), supports the floss spool 120, and allows for proper winding and unwinding/release of floss 200 (FIG. 1) relative to the floss spool 120. The spool rest 125 comprises a central shaft 126 that centrally supports the floss spool 120, a circular wall 127 that acts as a base for floss 200 (FIG. 1), a guiding element 128 for the floss positioned between holes 127A and 128A, and a plurality of anti-tilt support walls 129 that supports placement of the spool rest 125. The central shaft 126, the guiding element 128, and the plurality of anti-tilt support walls 129 extend from the circular wall 127. The circular wall 127 comprises a floss feed through hole 127A and a guide pocket 127B. The guiding element 128 comprises an opening 128A.

The floss spool 120 rests against the spring 130 and/or washer 135 on one side and engages with the actuator button 110 at the other end. The top body 102 once engaged with the bottom body 106, holds the floss spool 120 in the proper position, protects the internal components positioned in the cavity 109, and provides a guide path for the movement of the actuator button 110, thus creating the winding motion of the floss spool 120. When actuator button 110 is pressed, the floss spool 120 is permitted to turn (rotate), following grooves within the top body 102. When released, the floss spool 120 returns to its original position, and the floss spool 120 has to rotate by a prescribed amount as determined by the guides 122 on the floss spool 120 and within the top body 102.

In another embodiment (not shown in figures), the spool rest 125, washer(s) 135, spring 130, and floss spool 120 may be replaced (substituted) with a self-contained cartridge instead of individual, separate parts for ease of assembly with little to no variation in functionality.

In another embodiment (not shown in figures), the parts may be color-coded and labeled to denote the direction of floss 200 winding on floss spool 120, if the floss 200 needs to be replaced, or re-threaded in the event of breakage of floss 200.

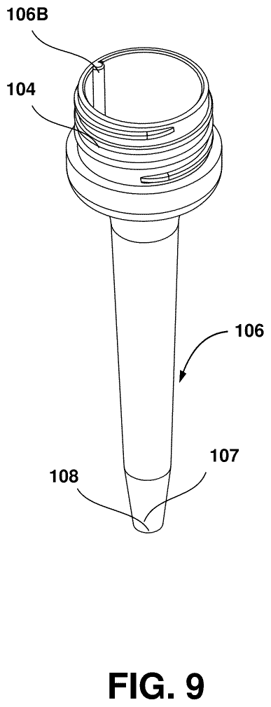

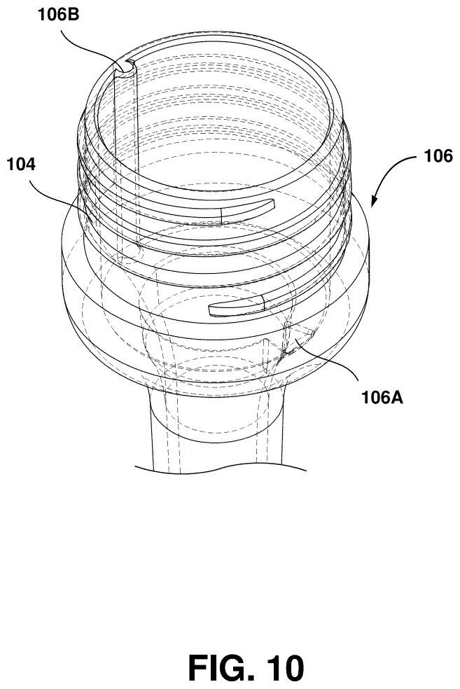

FIG. 9 and FIG. 10 illustrate a perspective view and a sectional perspective view of a bottom body 106 of the handle 100 respectively, according to an embodiment of the present invention. The bottom body 106 further comprises a floss feed through channel 106A and a guide boss 106B.

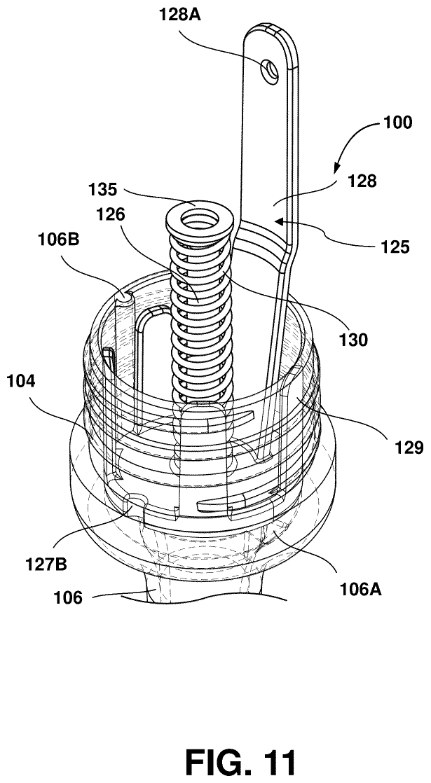

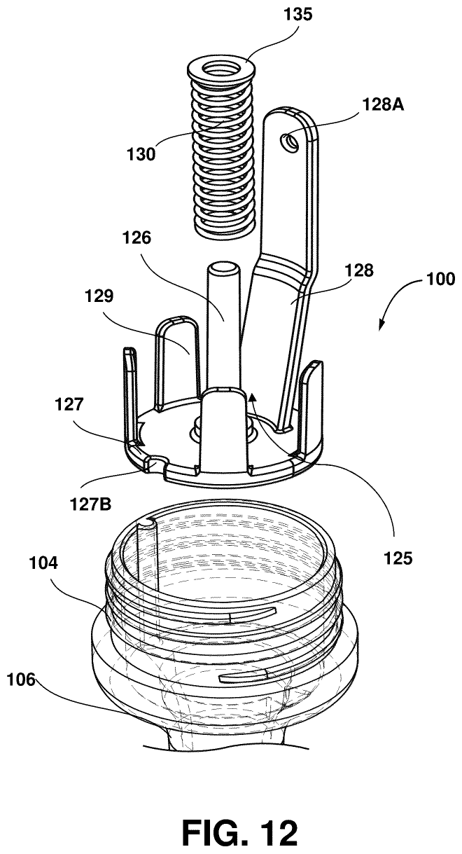

Referring to FIG. 11 and FIG. 12 that illustrate a sectional perspective view of the handle 100 in the assembled position, wherein floss spool 120 is not shown for the sake of simplicity and ease of understanding. The guide pocket 127B engages with the guide boss 106B. The floss feed through channel 106A, the floss feed through hole 127A, the guide pocket 127B and the opening 128A together collectively define a passage for dispensing the dental floss 200 (FIG. 1) through a dispensing hole 108.

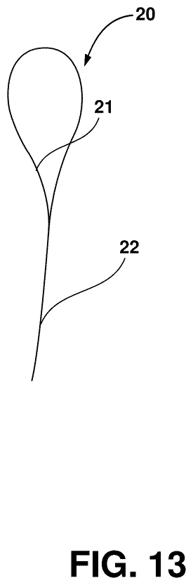

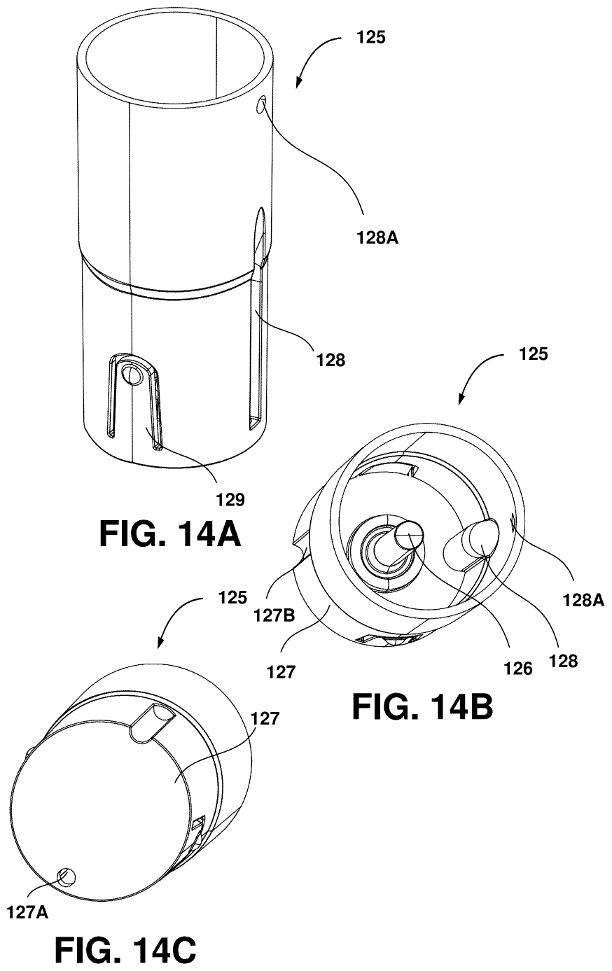

FIG. 13 illustrates a floss threader 20 is used to thread floss 200 between and through the various parts (as described above) of each of the handles 100. The floss threader 20 is flexible and the floss threader 20 comprises a knot 21 and an elongated portion 22. The user can tie and/or place floss 200 on the knot 21 and then the user can pull the elongated portion 22 using their hands such that the dental floss is passed (threaded) through various parts of the handle 100. The floss threader 20 could be used to set up (form) the dental flossing device 10. The floss 200 could be threaded through various parts of the handle 100 by the floss threader 20 to connect the floss 200 with both handles 100 when loading a new spool of floss 200, or to re-thread, if the floss 200 breaks and needs to be re-threaded.

The flossing kit or system further includes a case (not shown). The case may preferably be made of plastic and used to store the flossing device 10 when it is not being used. The case is generally rectangular in shape or be made narrower at tips 107 and wider at handles 100 to form the shape of candy corn but not so tapered. The case is shaped such as to accommodate a tongue scraper made of plastic or metal

The various components and parts of the various embodiments of the dental flossing device 10 of the present invention are similar and interchangeable. It is obvious to the one skilled in the art that the various components, and parts of the dental flossing device 10 of one embodiment of the present invention could be considered for other embodiments with little or no variation. Further, the material used for the construction of the dental flossing device 10 could include any material such as but not limited to: metal, plastic, wood, and so on.

It should be understood according to the preceding description of the present invention that the same is susceptible to changes, modifications and adaptations, and that the said changes, modifications and adaptations fall within scope of the appended claims.

What is claimed is:

1. A dental flossing device (10) for cleaning the teeth of a user, comprising:
a pair of handles (100) interconnected together by a floss (200), wherein each handle (100) of the pair of handles (100) comprises a top body (102) and a bottom body (106) connected together to define a cavity (109), wherein the bottom body (106) includes a tip (107) with a dispensing hole (108) to allow dental floss (200) to be dispensed there through;
a floss spool (120) positioned inside the cavity (109) to store and selectively release the floss (200) through the dispensing hole (108), wherein the floss spool (120) engages with an actuator button (110) configured at the top body (102) to selectively wind, and unwind a predetermined length of floss (200); and
a spool rest (125) positioned inside the cavity (109) and configured for guiding the floss (200), supporting the floss spool (120), and allowing for winding and unwinding of floss (200) relative to the floss spool (120).

2. The dental flossing device (10) of claim 1, wherein the floss (200) is made of a flexible material selected from at least synthetic waxed nylon, Teflon, and silk.

3. The dental flossing device (10) of claim 1, wherein the top body (102), and the bottom body (106) are removably connected using a screw thread arrangement (104).

4. The dental flossing device (10) of claim 1, wherein the bottom body (106) comprising:
a tip (107) with a dispensing hole (108) to allow dental floss (200) to pass through the floss spool (120);
a floss feed through channel (106A); and
a guide boss (106B).

5. The dental flossing device (10) of claim 1, wherein the tapered end of the tip (107) is rounded to avoid damage to the floss (200), and damage to the user's gingival tissue.

6. The dental flossing device (10) of claim 1, wherein the tip (107) further comprises an attachment made of a softer material for greater comfort adjacent to gums when flossing with the dental flossing device (10).

7. The dental flossing device (10) of claim 1 further comprising a clip-on attachment configured to re-direct the floss (200) as the floss (200) leaves the tip (107) to permit flossing under a wire when orthodontic brackets and wires are in place.

8. The dental flossing device (10) of claim 1, wherein the actuator button (110) is depressible and configured at the top of the top body (102) to selectively wind and unwind the predetermined length of floss (200).

9. The dental flossing device (10) of claim 1, wherein the top body (102) of each of the handle (100) comprises an ergonomically designed gripping portion (103) to allow the users to grip the top body (102) using their hands.

10. The dental flossing device (10) of claim 1, wherein the top body (102) and the bottom body (106) are removably connected by a connection mechanism selected from a group of mechanisms consisting of a luer lock, a twist lock, magnetic coupling, friction coupling, snap-fit coupling, key and keyways, screw and bolt coupling.

11. The dental flossing device (10) of claim 1, wherein the floss spool (120) comprises a plurality of guides (122) to enable rotation of the flash spool (120) by a predetermined distance when the actuator button (110) is actuated either to wind or unwind the floss (200).

12. The dental flossing device (10) of claim 10, wherein the depth and number of guides (122) are adjustable to alter the predetermined distance of floss (200) that's unwinded or winded up with pressing of the actuator button (110).

13. The dental flossing device (10) of claim 1, wherein the floss spool (120) is configured to engage with the floss (200) utilizing a means of engagement that connects a hole (120A) located on a central shaft (120B) of the floss spool (120).

14. The dental flossing device (10) of claim 1 further comprising at least:
a spring (130) positioned between the spool rest (125) and the floss spool (120) inside the cavity (109), wherein the spring (130) is adapted to deliver the necessary force to counter the force exerted when the actuator button (110) is depressed, and effectively causes spooling of the floss (200) as the floss spool (120) engages with the actuator button (110); and
a washer (135) placed on one or both ends of the spring (130) to allow for free movement and rotation of spring (130) during the action of spooling.

15. The dental flossing device (10) of claim 1, wherein the spool rest (125) comprising:
a central shaft (126) that centrally supports the floss spool (120);
a circular wall (127) that acts as a base for floss (200), wherein the circular wall (127) comprises a floss feed through a hole (127A), and a guide pocket (127B);
a guiding element (128) for the floss along the spool rest, wherein the guiding element (128) comprises an opening (128A);
a plurality of anti-tilt support walls (129) that support the placement of the spool rest (125); and
wherein the central shaft (126), the guiding element (128), and the plurality of anti-tilt support walls (129) extend from the circular wall (127).

16. The dental flossing device (10) of claim 1, wherein the floss spool (120) rests against the spring (130) and/or the washer (135) on one end and engages with the actuator button (110) at the other end.

17. The dental flossing device (10) of claim 1, wherein the actuator button (110) when pressed, the floss spool (120) turns following the plurality of guides (122) within the top body (102), and the actuator button (110) when released, the floss spool (120) returns to its original position, and the floss spool (120) rotates by a prescribed amount as determined by the guides (122) on the floss spool (120) and within the top body (102).

18. The dental flossing device (10) of claim 15, wherein the floss feed through hole (127A), the guide pocket (127B), the opening (128A), the floss feed through channel (106A) of the bottom body (106) together collectively define a passage for dispensing the dental floss (200) through a dispensing hole (108).

19. The dental flossing device (10) of claim 1, wherein the floss (200) is guided and threaded between and through the various parts of each of the handles (100) using a floss threader (20).

20. The dental flossing device (10) of claim 1, wherein the handles (100) are configured to allow for winding the floss 200 in opposite directions.

21. A dental flossing system (10,20) for cleaning the teeth of a user, comprising:
a pair of handles (100) interconnected together by a floss (200), wherein each handle (100) of the pair of handles (100) comprises a top body (102) and a bottom body (106) connected together to define a cavity (109), wherein the bottom body (106) includes a tip (107) with a dispensing hole (108) to allow dental floss (200) to be dispensed there through;
a floss spool (120) positioned inside the cavity (109) to store and selectively release the floss (200) through the dispensing hole (108), wherein the floss spool (120) engages with an actuator button (110) configured at the top body (102) to selectively wind, and unwind a predetermined length of floss (200);
a spool rest (125) positioned inside the cavity (109) and configured for guiding the floss (200), supporting the floss spool (120), and allowing for winding and unwinding of floss (200) relative to the floss spool (120); and
a floss threader (20) adapted to guide and thread the floss (200) between and through the various parts of each of the handles (100).

22. The dental flossing system (10,20) of claim 21, wherein the floss threader (20) is flexible and comprises a knot (21) to which the floss (200) is tied, and an elongated portion (22) that's pulled by the user such that the dental floss (200) is threaded through various parts of the handle (100).

23. A dental flossing system (10,20) for cleaning the teeth of a user, comprising:
a pair of handles (100) interconnected together by a floss (200), wherein each handle (100) of the pair of handles (100) comprises a top body (102) and a bottom body (106) connected together to define a cavity (109), wherein the bottom body (106) includes a tip (107) with a dispensing hole (108) to allow dental floss (200) to be dispensed there through;
a floss spool (120) positioned inside the cavity (109) to store and selectively release the floss (200) through the dispensing hole (108), wherein the floss spool (120) engages with an actuator button (110) configured at the top body (102) to selectively wind, and unwind a predetermined length of floss (200);
a spool rest (125) positioned inside the cavity (109) and configured for guiding the floss (200), supporting the floss spool (120), and allowing for winding and unwinding of floss (200) relative to the floss spool (120);
a floss threader (20) adapted to guide and thread the floss (200) between and through the various parts of each of the handles (100); and
a case adapted to store the flossing device 10 when it is not being used.

24. The dental flossing system (10,20) of claim 23, wherein the case is at least substantially rectangular, or made narrower at tips (107) and wider at handles (100) to form the shape of candy corn.
